(19) United States
(12) Patent Application Publication
(10) Pub. No.: US 2018/0329726 A1
(43) Pub. Date: Nov. 15, 2018

(54) ASSOCIATING A USER-ACTIVATABLE ELEMENT WITH RECORDED USER ACTIONS

(71) Applicant: ENT. SERVICES DEVELOPMENT CORPORATION LP, Houston, TX (US)

(72) Inventors: Joshua HAILPERN, San Jose, CA (US); William J. ALLEN, Corvallis, OR (US); Harold S. MERKEL, Houston, TX (US); Ronald CALVO ROJAS, San José (CR)

(73) Assignee: ENT. SERVICES DEVELOPMENT CORPORATION LP, Houston, TX (US)

(21) Appl. No.: 15/771,071

(22) PCT Filed: Oct. 28, 2015
(86) PCT No.: PCT/US2015/057726

§ 371 Date: Apr. 25, 2018

(51) Int. Cl. G06F 9/451; G06F 3/0481; G06F 11/34

(52) U.S. Cl. CPC G06F 9/451; G06F 11/3438; G06F 3/04817

(57) ABSTRACT

Example implementations relate to recorded user actions. For example, user actions in a plurality of different environments are recorded, and a user-activatable element is associated with the recorded user actions. The user-activatable element is caused to be presented.

### BACKGROUND

A user can interact with various applications executed in a system. Examples of such applications include an email application, a calendar application, a word processing application, an online meeting application, and so forth.

### BRIEF DESCRIPTION OF THE DRAWINGS

Some implementations are described with respect to the following figures.

FIG. 1 is a block diagram of an example system including a user-activatable element programming engine and a user action replay engine, according to some implementations.

FIG. 2 illustrates an example of replaying user actions to generate a report, according to further implementations.

FIG. 3 is a flow diagram of an example process to set up a customized user-activatable element, according to some implementations.

FIG. 4 is a flow diagram of an example process of replaying user actions associated with a customized user-activatable element, according to some implementations.

FIG. 5 is a block diagram of an example arrangement including systems that can share a template including information of recorded user actions, according to some implementations.

FIG. 6 is a flow diagram of an example process of a learning mode according to some implementations.

FIG. 7 illustrates an example context of use of applications, according to some implementations.

FIGS. 8 and 9 are block diagrams of example systems according to some implementations.

### DETAILED DESCRIPTION

Users can perform actions in several different environments as part of an overall process, such as generating a periodic report (e.g. weekly report or monthly report), participating in an online meeting, chatting with product developers, and so forth. An “environment” can refer to an arrangement of any or some combination of the following elements that can be provided by a program code (including machine-readable instructions executable by a processor): a user interface, control elements activatable to control activities, an output mechanism to present audio, video, and/or multimedia content, and so forth. A program code can be an application, where different applications can provide respective different environments. Examples of applications include an email application to send emails, a text messaging application to send text messages, a voice call application to make phone calls, an online meeting application to establish online meetings (for voice conference calls, video conference calls, etc.), a calendar application to keep track of scheduled events and due dates, a document sharing application to allow users to share applications with each other, and so forth. In further examples, a program code can be an operating system, firmware code, and/or any other type of program code.

In additional examples, the different program codes can be distributed across multiple systems, including systems in a cloud, where the systems are accessible over the Internet or other type of network. A system can include any or some combination of the following, as examples: a desktop computer, a notebook computer, a tablet computer, a server computer, a communication node, a smart phone, a wearable device (e.g. smart watch, smart eyeglasses, etc.), a game appliance, a television set-top box, a vehicle, or any other type of electronic device.

As part of their work, users can be involved in repetitive computer-based actions, in which the same actions are repeated again and again as users access services of respective program codes. Having to repeat the same actions can be time consuming, can lead to mistakes, can reduce worker productivity, or can increase user frustration.

In accordance with some implementations of the present disclosure, techniques or mechanisms are provided to allow users to customize user-activatable elements with respective user actions that can be made across multiple different environments. In response to user selection to program a user-activatable element, user actions made in the multiple environments can be recorded, and such recorded user actions can be associated with the dynamically programmable user-activatable element that can be presented (e.g. displayed or otherwise made available to the user for selection) and activated by a user to replay the recorded user actions. Examples of the user-activatable element include a key (referred to as a “hot key”) presented in a user interface (UI), a control button, a menu item of a menu, or any other control element that can be activated by a user by making a selection in the UI, such as with a user input device including a mouse device, a touchpad, a keyboard, a touch-sensitive display screen, and so forth.

In response to user activation of the user-activatable element, the recorded user actions made in multiple different environments can be performed, so that a user can avoid having to manually repeat such user actions. Instead, a simple activation of the user-activatable element initiates the performance of the user actions in the different environments. By allowing a user to program a customized user-activatable element across multiple technologies corresponding to the multiple environments, greater flexibility and convenience may be afforded the user.

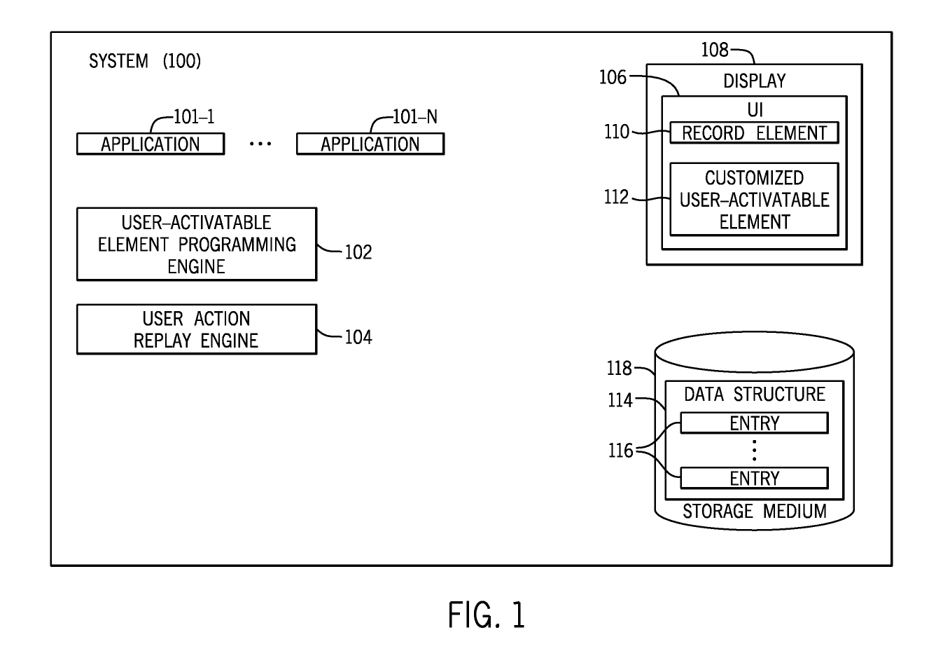

FIG. 1 is a block diagram of an example system 100 that includes multiple applications (application 101-1 to application 101-N, where N>1). Although reference is made to “applications” in the ensuing disclosure, it is noted that techniques or mechanisms according to some implementations can be applied to other types of program codes in other examples.

A user of the system 100 can interact with the applications to perform various tasks. Although applications 101-1 to 101-N are depicted as being part of the system 100, it is noted that any one or multiple of the applications can be executed on another system that is separate from the system 100. For example, an application can be executed remotely on a remote server system or a cloud system accessible over a network.

In some examples, each application can provide a respective different UI through which the user can interact with the corresponding application. Thus, in such examples, application 101-1 presents a first UI through which the user can interact with application 101-1. Application 101-N can present another UI through which the user can interact with application 101-N.

In other examples, a unified UI can be presented that includes control elements associated with the different applications. This unified UI can include control elements for the multiple applications, as well as information content items output or otherwise related to the respective multiple applications. An information content item can be an email, a meeting notice, a text document, an audio file, a video file, a calendar event, and so forth. An example of such unified UI is described in PCT Application No. PCT/US2014/044940, entitled “Automatic Association of Content from Sources,” filed on Jun. 30, 2014.

The system 100 includes a user-activatable element programming engine 102 and a user action replay engine 104, according to some implementations. An “engine” can refer to processing hardware, including a microprocessor, a core of a multi-core microprocessor, a microcontroller, a programmable gate array (PGA), an application specific integrated circuit (ASIC), or any other type of hardware processing circuitry. An engine can be implemented with just processing hardware, or as a combination of processing hardware and machine-readable instructions executable by the processing hardware. The machine-readable instructions can be in the form of software and/or firmware.

In some examples, the user-activatable element programming engine 102 can present a UI 106, such as a graphical user interface (GUI), that displays various control elements and other information of the user-activatable element programming engine 102. Note that the UI 106 of the user-activatable element programming engine 102 can be separate from the UIs of the applications 101-1 to 101-N (or a unified UI for the applications 101-1 to 101-N). The UI 106 can be displayed in a display 108 of the system 100.

In accordance with some implementations of the present disclosure, the user-activatable element programming engine 102 can present a record element 110 (e.g. a record key, a record button, a record icon, a record menu element, etc.) in the UI 106. The record element 110 is user selectable (e.g. selection with a user input device such as a mouse device, touchpad, keyboard, or touch-sensitive display screen) to cause programming of a customized user-activatable element, to associate the customized user-activatable element with recorded user actions.

When the record element 110 is selected, the user-activatable element programming engine 102 can start recording user actions made with respect to the applications. Examples of user actions made with respect to the applications can include opening an application, preparing an email with an email application and sending the email to selected recipients, using a messaging application to perform instant messaging with other users, checking a calendar application for scheduled events, joining an online meeting at a scheduled time using an online meeting application, and so forth. Note that the foregoing collection of tasks may be repeated by the user of the system 100 on a periodic basis, such as on a daily, weekly, or other periodic basis. As an example, the foregoing collection of user actions can be part of an overall process that the user performs every morning when the user shows up to work. Having to manually perform the respective user actions on an individual basis can be inefficient.

Another example overall process can include preparing a report, such as a weekly, quarterly, or annual progress report. In this report preparing example, the record element 110 can be selected to cause the user-activatable element programming engine 102 to record user actions associated with preparing a report. As part of preparing such a periodic report, a user can be presented with relevant emails, instant messages, calendar events, meeting summaries, tasks completed, documents shared, and other artifacts; such artifacts can be added to the report. In examples where a unified UI (such as that described in PCT Application No. PCT/US2014/044940) is used, artifacts related to a particular topic can be collected as a user uses the unified UI to interact with various applications. For example, a topic can be “Reporting Progress/Status.” Thus, any artifacts from different sources (e.g. different applications) related to the topic can be collected during use of the UI, and these artifacts along with the recorded user actions can be stored and associated with a respective customized user-activatable element (e.g. a “Reporting” element) that can be used to produce a report (without the user actually having to perform the manual tasks associated with such report preparation, including searching for and finding artifacts).

In some examples, the artifacts can be analyzed by the system 100 and analytic results can also be collected. For example, the analytic results can include hours worked on a given task, a number of emails relating to a given subject, an amount of time spent in meetings about a given task, a number of reports published, and so forth.

When recording the user actions, it is noted that the user-activatable element programming engine 102 can actually perform some modification of the user actions, such as by hiding personal information (names, email addresses, companies, etc.) of users so that when the recorded user actions are replayed, such personal information are redacted.

Once a target collection of user actions has been recorded by the user-activatable element programming engine 102, the user can perform another control action, such as selecting the record element 110 again or by selecting a different control element, to stop the recording. In response to the stopping of the recording, the user-activatable element programming engine 102 can configure a customized user-activatable element 112 and associate the recorded user actions with the customized user-activatable element 112, which can be presented in the UI 106. The presentation of the customized user-activatable element 112 can be performed by the user-activatable element programming engine 102 or the user action replay engine 104. Presenting the customized user-activatable element 112 in the UI can include (1) displaying the customized user-activatable element 112 so that the customized user-activatable element 112 is available for user selection, or (2) otherwise making the customized user-activatable element 112 available for selection by a user, even if the customized user-activatable element 112 is not visible to the user in the UI but is a tactile (e.g. haptic) user-activatable element that can be located in some predetermined location in the UI.

The user-activatable element programming engine 102 can store the association between the customized user-activatable element 112 and a respective collection of recorded user actions in an entry 116 of a data structure 114 (e.g. an association table or other type of data structure). Multiple entries 116 of the data structure 114 can correspond to respective different customized user-activatable elements. Each entry 116 includes information identifying the respective customized user-activatable element and information describing the respective collection of recorded user actions. The data structure 114 can be stored in a storage medium 118.

Although the customized user-activatable element 112 set up by the user-activatable element programming engine 102 is depicted in FIG. 1 as being presented in the same UI 106 as the record element 110, it is noted that in other examples, the customized user-activatable element 112 can be presented in a different UI, such as a UI for one or multiple of the applications 101-1 to 101-N, or a unified UI for the multiple applications 101-1 to 101-N.

Once the customized user-activatable element 112 is set up and caused to be presented in the UI 106 by the user-activatable element programming engine 102, the user action replay engine 104 can monitor for activation of the customized user-activatable element 112. User selection of the customized user-activatable element 112 can be communicated as an event to the user action replay engine 104. In response to such event indicating selection of the customized user-activatable element 112, the user action replay engine 104 can access the data structure 114 to retrieve information from a corresponding entry 116 to determine the recorded user actions that are associated with the customized user-activatable element 112. The user action replay engine 104 can then replay the recorded user actions associated with the user-activatable element 112, including opening applications (when appropriate, such as when an application is not yet opened) and performing the recorded user actions made with respect to the applications (e.g. a user selecting control buttons, preparing an email, sending a document to another user, etc.).

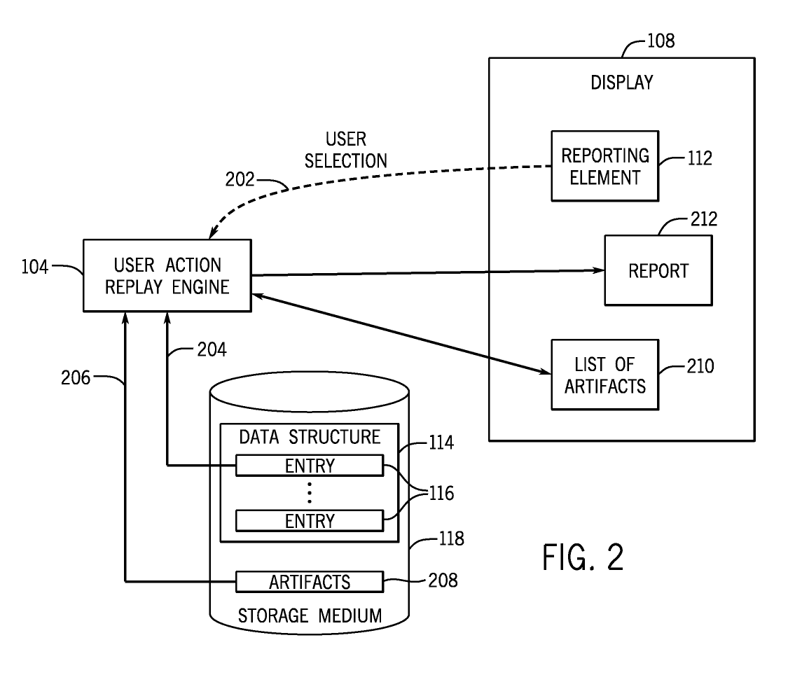

As shown in FIG. 2, in examples where the customized user-activatable element 112 is a “Reporting” element to produce a report 212, user selection (202) of the “Reporting” element causes the user action replay engine 104 to retrieve (204) a respective collection of recorded user actions (user actions associated with producing a report) from a respective entry 116 of the data structure 114, and retrieve (206) any stored artifacts 208 (e.g. emails, instant messages, calendar events, meeting summaries, tasks completed, documents shared, etc.) associated with the report. The user action replay engine 104 can present, in a window displayed by the display 108, a list 210 of the artifacts. The artifacts added to the list 210 can be filtered by the user action replay engine 104 based on one or multiple filter criteria, such as time range (artifacts created/modified during a specific time range), relevancy of the artifacts to a subject, and so forth. Each artifact in the list 210 can be associated with an add icon (e.g. “+” icon or other icon) that is user selectable to add a respective artifact to the report 212. In other examples, instead of presenting the retrieved artifacts to allow the user to add such artifacts to the report, the artifacts can be automatically added to the report 212. More generally, the artifacts associated with the customized user-activated element 112 can be presented for inclusion into an output (e.g. the report 212) produced by replay of the recorded actions.

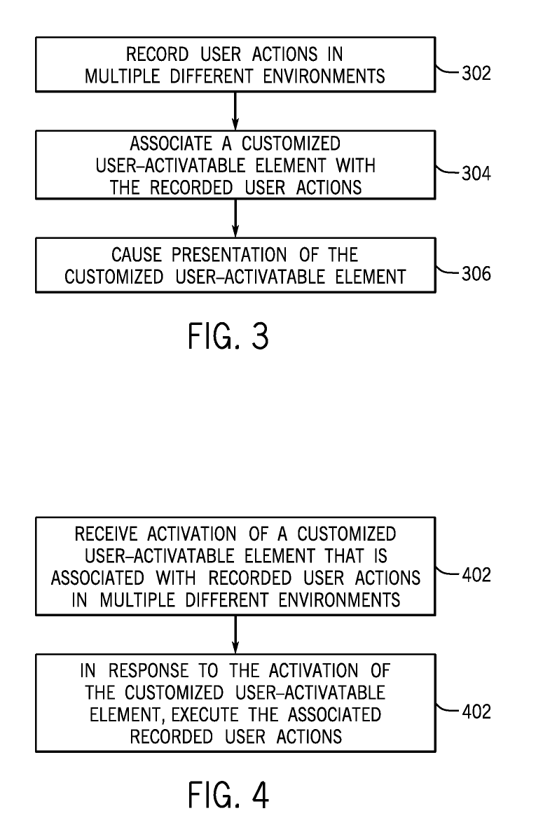

FIG. 3 is a flow diagram of an example process that can be performed by the user-activatable element programming engine 102 according to some implementations. The user-activatable element programming engine 102 records (at 302) user actions in multiple different environments, including environments provided by multiple applications, for example. The recording can be initiated in response to a user input, such as user selection of the record element 110 (FIG. 1).

Initiation of the recording starts a record mode, in which user actions of made with respect to different applications can be monitored and recorded. During use of the applications, different ones of the applications can be in focus at different times. An application is in focus when a UI of the application is one that is currently active to allow a user to interact with the UI. To determine which application a user action is associated with, the user-activatable element programming engine 102 can either (1) analyze displayed pixels in a target portion of content displayed by the display 108 (e.g. a top portion of the content displayed by the display 108), or (2) send a request to an operating system (or more specifically, an application manager of the operating systems that manages applications) to ask the operating system which application is in focus.

With technique (1) above, the operating system may cause a name of the application that is currently in focus to appear in the top portion of the content displayed by the display 108. The user-activatable element programming engine 102 can perform image processing of the top portion to identify the name (or other identifier) of the application appearing in the top portion, which is the application in focus.

With technique (2) above, the user-activatable element programming engine 102 can send an inquiry to the application manager of the operating system in the system 100 to seek information regarding which application is in focus. The application manager can respond with the name or other identifier of the application in focus.

In examples where a unified UI is presented for multiple applications, the underlying management engine for the unified UI can associated different control elements in the unified UI with the respective applications, so that the management engine can indicate to the user-activatable element programming engine 102 which application a recorded user action is associated with.

The user-activatable element programming engine 102 associates (at 304) a customized user-activatable element (e.g. 112) with the recorded user actions. Such association can be stored in a data structure entry 116 of FIG. 1.

The user-activatable element programming engine 102 causes (at 306) presentation of the customized user-activatable element (e.g. 112) in a UI, which can be the UI 106 presented by the user-activatable element programming engine 102 (as shown in FIG. 1), a UI presented by an application, or a unified UI. Causing presentation of the customized user-activatable element in the UI can include (1) causing display of the customized user-activatable element so that the customized user-activatable element is available for user selection, or (2) otherwise making the customized user-activatable element available for selection by a user, even if the customized user-activatable element is not visible to the user in the UI but is a tactile (e.g. haptic) user-activatable element that can be located in some predetermined location in the UI.

FIG. 4 is a flow diagram of an example process performed by the user action replay engine 104 according to some implementations. The user action replay engine 104 receives (at 402) activation of a customized user-activatable element (e.g. 112 in FIG. 1) that is presented in a UI and is associated with recorded user actions in multiple different environments. In response to the activation of the customized user-activatable element, the user action replay engine 104 executes (at 404) the recorded user actions in the multiple different environments.

The user action replay engine 104 can access the association data structure 114 (FIG. 1) to retrieve an entry 116 that corresponds to the activated customized user-activatable element. The retrieved entry 116 includes information describing the recorded user actions associated with the activated customized user-activatable element.

The execution of the recorded user actions includes replaying the recorded user actions. For example, user inputs made with respect to applications can be simulated by the user action replay engine 104, e.g. opening applications, by simulating user click actions with respect to control elements, simulating text entries in entry boxes, preparing and sending emails, preparing and sending instant messages, sharing documents, and so forth.

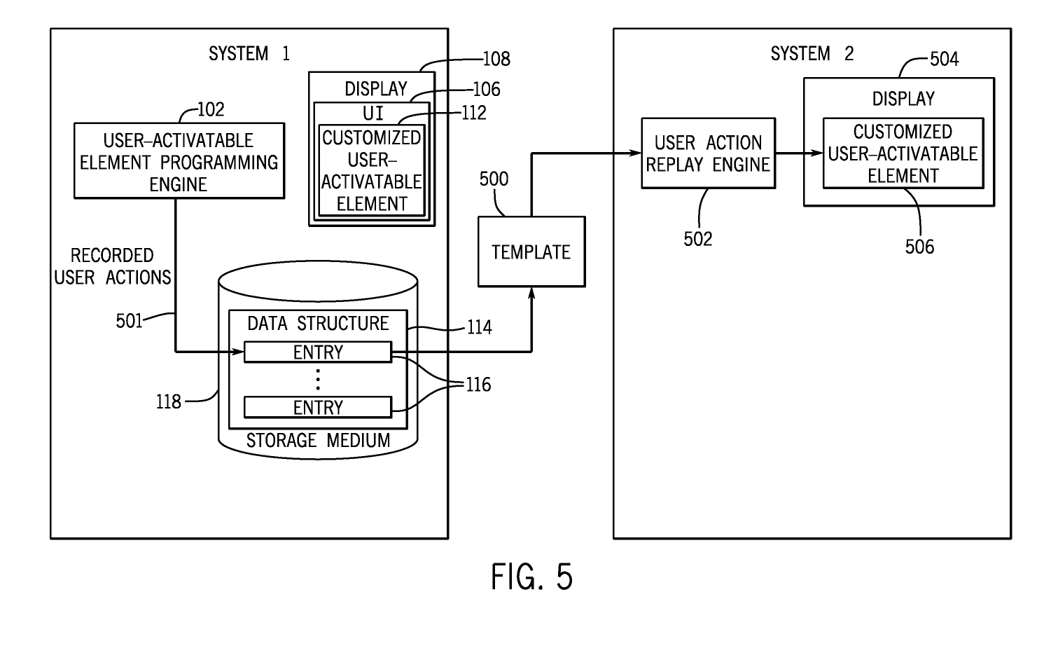

In further implementations, as shown in FIG. 5, recorded user actions associated with the customized user-activatable element 112 can be included in a template 500 for the customized user-activatable element 112. The template 500 can include information contained in the respective entry 116 of the association data structure 114, for example. As shown in FIG. 5, information relating to recorded user actions associated with the user-activatable element 112 is stored (501) in the respective entry 116 of the association data structure 114 in system 1. Information from the respective entry 116 can be used to populate the template 500, which can be shared with multiple users, such as with users using other systems. In FIG. 5, the template 500 can be sent by system 1 over a network to system 2 (or multiple other systems).

At system 2, a user action replay engine 502 (similar to the user action replay engine 104 discussed above) can use the template 500 to cause the customized user-activatable element 112 to be displayed in a display 504 in system 2 as 506, so that a user at system 2 can activate the customized user-activatable element 506 to replay the associated recorded user actions at system 2.

In the foregoing, reference is made to a record mode in which the user-activatable element programming engine 102 can record a collection of user actions taken in environments provided by various applications.

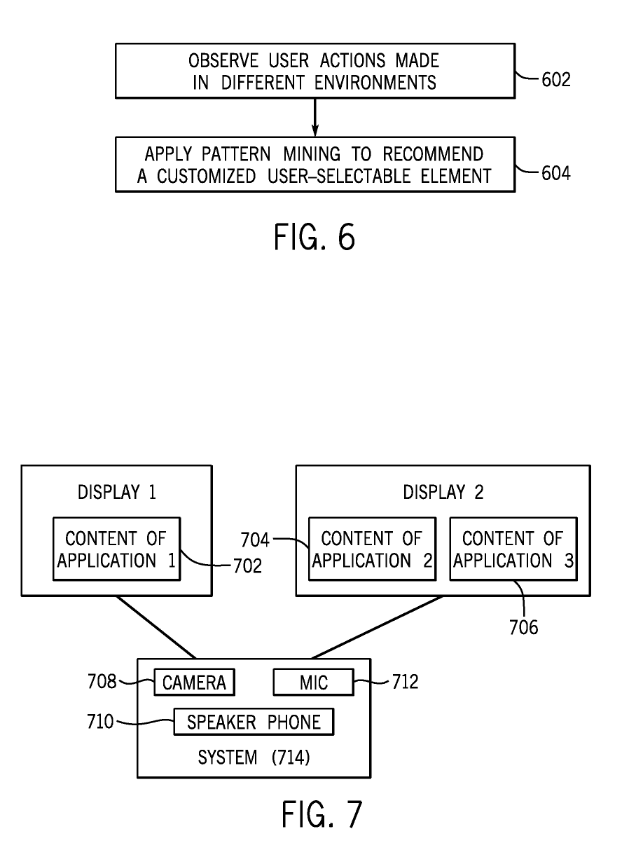

In other implementations, a learning mode can also be provided. FIG. 6 is a flow diagram of an example process for the learning mode. In the learning mode, the user-activatable element programming engine 102 can observe (at 602) user actions made in different environments. The user-activatable element programming engine 102 can apply (at 604) pattern mining can be performed so that the user-activatable element programming engine 102 can cause creation of customized user-activatable elements based on the observed user actions, which may be made by a user or multiple users in one system or multiple systems. With the learning mode, the user-activatable element programming engine 102 can cause creation of a further customized user-activatable element that is associated with a collection of user actions based on observed user actions.

In the learning mode, rather than a user initiating the recording of user actions to associate with a customized user-activatable element, it is the user-activatable element programming engine 102 that recommends the creation of a customized user-activatable element programming engine 102, based on the monitoring of the behavior of one or multiple users.

Examples of pattern mining on observed user actions that can be performed can include any of various different pattern mining techniques, such as a pattern mining technique described in Xiaoxin Yin, entitled “CPAR: Classification based on Predictive Association Rules,” dated 2003. Another example of a pattern mining technique that can be employed includes a pattern mining technique described in Joshua Hailpern, entitled “Truncation: All the News That Fits We'll Print,” dated September 2014. In other examples, other pattern mining techniques can be employed. Based on the pattern mining technique of Hailpern, a Kullback-Leibler (KL) divergence technique can be developed that produces a model of observed user actions.

As an example, if a user is consistently looking at a calendar for the next day, and sending a reminder email to designated recipients regarding meetings occurring on the next day, the user-activatable element programming engine 102 can detect this pattern, and suggest that a user-activatable element be configured that includes such user actions.

Although reference is made to recording user actions (which are considered “direct actions” made by a user), in further implementations, the user-activatable element programming engine 102 can also associate “indirect actions” with a customized user-activatable element that is configured by the user-activatable element programming engine 102. “Indirect actions” can refer to actions that are related to the applications, but which are not made with respect to the applications (examples of direct actions include opening an application, making a control selection in an application, preparing a document using an application, etc.). An indirect action can include an action relating to a context of use of an application (e.g. where content of the application is displayed, how the content is displayed, what hardware or software components are activated when using the application, etc.). Information pertaining to the indirect user actions can also be recorded in a respective entry 116 of the association data structure 114 (FIG. 1).

For example, as shown in FIG. 7, when using applications in an overall process, a user may concurrently view multiple windows 702, 704, and 706, which can be presented in one or multiple displays (e.g. display 1 and display 2 in FIG. 7). As an example, a user may start an online meeting application and view the content of the online meeting application in a first window, and view the content of an email application in a second window. In addition, the user may also activate various hardware components of a system 714, where the hardware components can include a camera 708, a speaker phone 710, a microphone 712, and so forth. These activated hardware components are bound to the use of the applications in the overall process. Similarly, the user may also activate various software components during use of the applications, where these software components are bound to the use of the applications. Moreover, each of the windows can have specific arrangements: window 1 for the online meeting application having a first size, window 2 for the email application having a smaller size, window 3 for another application minimized, and so forth.

During replay by the user action replay engine (104 or 502), the user action replay engine can cause both direct actions (the recorded user actions made with respect to various applications) and indirect actions (e.g. sizing windows, activating hardware components, activating software components, etc.) to be replayed.

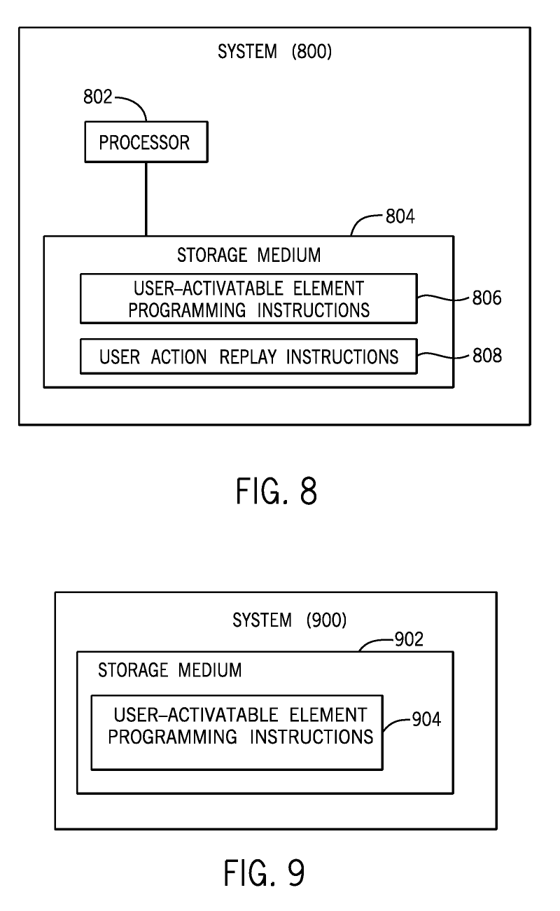

FIG. 8 is a block diagram of an example system 800 (which can include an electronic device or multiple electronic devices) that includes a processor (or multiple processors) 802. A processor can include a microprocessor, a core of a multi-core processor, a microcontroller, an application specific integrated circuit, programmable gate array, or other processing hardware.

The system further includes a non-transitory machine-readable or computer-readable storage medium (or storage media) 804, which store(s) machine-readable instructions executable on the processor(s) 802. The storage medium (or storage media) 804 can include one or multiple different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

The machine-readable instructions include user-activatable element programming instructions 806 (which can be part of the user-activatable element programming engine 102 of FIG. 1, for example), and user action replay instructions 808 (which can be part of the user action replay engine 104 of FIG. 1, for example).

The user-activatable element programming instructions 806 can perform various tasks of the user-activatable element programming engine 102 discussed above, such as recording (e.g. 302 in FIG. 3) user actions made with respect to applications running on one or multiple systems, recording (e.g. 302 in FIG. 3) indirect user actions associated with use of the applications, associating (e.g. 304 in FIG. 3) a customized user-activatable element with the recorded user actions and the indirect user actions, and causing presentation (e.g. 306 in FIG. 3) of the customized user-activatable element.

The user action replay instructions 808 can perform various tasks of the user action replay engine 104 discussed above, such as, in response to activation of the customized user-activatable element, causing replay (e.g. 402 in FIG. 4) of the recorded user actions and the indirect user actions.

FIG. 9 is a block diagram of another example system 900 according to some implementations. The system 900 includes a non-transitory machine-readable or computer-readable storage medium (or storage media) 902, which store(s) machine-readable instructions executable in the system 900. The machine-readable instructions stored in the storage medium (or storage media) 902 include user-activatable element programming instructions 904 that can perform various tasks of the user-activatable element programming engine 102 discussed above, such as recording (e.g. 302 in FIG. 3) user actions in different environments, associating (e.g. 304 in FIG. 3) a user-activatable element with the recorded user actions, and causing presentation (e.g. 306 in FIG. 3) of the user-activatable element.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. An article comprising a non-transitory machine-readable storage medium storing instructions that upon execution cause a system to:
record user actions in a plurality of different environments;
associate a user-activatable element with the recorded user actions; and
cause presentation of the user-activatable element.

2. The article of claim 1, wherein the instructions upon execution cause the system to further:
receive a user selection to program the user-activatable element, wherein the recording is initiated in response to the received user selection.

3. The article of claim 1, wherein the recorded user actions comprise user interactions with control elements presented by different applications.

4. The article of claim 3, wherein the recording of the user actions comprises:
determining a given application of the different applications is currently in focus; and
identifying user actions made while the given application is currently in focus as being associated with the given application.

5. The article of claim 4, wherein the determining that the given application is currently in focus comprises processing pixels in a target portion of a user interface to locate an identifier of the given application.

6. The article of claim 4, wherein the determining that the given application is currently in focus comprises sending a request to an operating system to cause the operating system to identify which application is currently in focus.

7. The article of claim 1, wherein the associating of the user-activatable element with the recorded user actions comprises associating a hot key with the recorded user actions.

8. The article of claim 1, wherein the instructions upon execution cause the system to further:
observe user actions; and
cause creation of a further user-activatable element that is associated with a collection of user actions based on the observed user actions.

9. The article of claim 1, wherein the instructions upon execution cause the system to further:
record indirect user actions relating to a context of use of applications in the environments; and
associate the user-activatable element with the recorded indirect user actions

10. The article of claim 1, wherein the instructions upon execution cause the system to further:
record artifacts associated with the recorded user actions;
associate the recorded artifacts with the user-activatable element; and
in response to selection of the user-activatable element:
cause replay of the recorded user actions, and
present the recorded artifacts for inclusion in an output produced by the replay of the recorded user actions.

11. A method comprising:
receiving, by a system comprising a processor, activation of a presented user-activatable element that is associated with recorded user actions in a plurality of different environments; and
in response to the activation of the user-activatable element, executing, by the system, the recorded user actions in the plurality of different environments.

12. The method of claim 11, wherein executing the recorded user actions comprises:
replaying user actions made with respect to applications corresponding to the different environments; and
causing display of contents of the applications in a context of use of the applications.

13. The method of claim 12, wherein the context is at least one selected from among a display of the contents of the applications in respective different display windows, sizes of the display windows, hardware components bound to the use of the applications, and software components bound to the use of the applications.

14. A system comprising:
a processor; and
a non-transitory machine-readable storage medium storing instructions that are executable on the processor to:
record user actions made with respect to applications running on one or multiple systems;
record indirect user actions associated with use of the applications;
associate a customized user-activatable element with the recorded user actions and the indirect user actions;
cause presentation of the customized user-activatable element; and
in response to selection of the customized user-activatable element, cause replay of the recorded user actions and the indirect user actions.

15. The system of claim 14, wherein the instructions are executable on the processor to present a unified user interface for the applications, and wherein the recorded user actions are user actions made using the unified user interface.
